(19) United States
(12) Patent Application Publication
(10) Pub. No.: US 2016/0048867 A1
(43) Pub. Date: Feb. 18, 2016

(54) System for Repository Database

(71) Applicant: Bank of America Corporation, Charlotte, NC (US)

(72) Inventors: David Joa, Irvine, CA (US); Debashis Ghosh, Charlotte, NC (US); Kurt D. Newman, Matthews, NC (US); Mark Krein, Charlotte, NC (US); Timothy John Bendel, Charlotte, NC (US)

(21) Appl. No.: 14/925,407

(22) Filed: Oct. 28, 2015

Related U.S. Application Data
(63) Continuation-in-part of application No. 12/652,577, filed on Jan. 5, 2010.

(51) Int. Cl. G06Q 30/02

(52) U.S. Cl. CPC G06Q 30/0243; G06Q 30/0271; G06Q 30/0253

(57) ABSTRACT

Systems and methods for a transmitting data to and receiving data from a repository are provided. For instance, presenting a transmission to a customer during a transaction at a system which may include an optimization computer, a repository database which may store one or more transmissions and information regarding a particular audience to which the respective transmissions should be presented and a computer system configured to allow transmissions to be uploaded to the repository database are provided. The transmission may be presented at a point of transaction wherein the transaction is being conducted and the transaction data from the transaction being conducted at the point of transaction may be determined at the point of transaction and may be transmitted to the optimization computer. Further, the optimization computer may compare the transaction data with the information regarding a particular audience to which the respective transmissions should be presented and may select a transmission to be presented during the transaction based on the comparison of the transaction data with the information regarding a particular audience to which the respective transmissions should be presented.

### CROSS REFERENCE TO RELATED APPLICATIONS

This application is a continuation-in-part of and claims priority to co-pending U.S. patent application Ser. No. 12/652,577, entitled “Advertising During a Transaction,” and filed Jan. 5, 2010, which is incorporated herein by reference in its entirety.

### BACKGROUND

Effectiveness of various data transmissions may be an important factor to an entity. Generally, an entity who is presenting a transmission for a good or service attempts to do it as effectively as possible by presenting it in a format such that a potential customer will take an interest in the transmission or notification. If the potential customer does not take an interest in the transmission or notification, then it may not be as effective as if would have been if the customer did take an interest. Hence, such a transmission may not result in increased sales of the good or service. For example, if a customer is distracted and not paying attention to the transmission, then it may not be as effective. Similarly, if a particular product or service, or notification thereof, is transmitted to an audience that is unlikely to be interested in that particular product or service, then such transmission will generally be less effective than if that particular product or service, or notification thereof, is transmitted to an audience that is likely to be interested in that particular product or service. Therefore, it would be advantageous to have a system and method which increases the likelihood of the effectiveness of a transmission by presenting the transmission to a customer when the customer is more likely to pay attention to the particular product or service associated with the transmission.

### SUMMARY

In light of the above, a computer system for transmitting data to and receiving data from a repository database is provided. The systems and methods described present a transmission to a customer during a transaction wherein the likelihood that the customer may be interested in the particular product or service associated with the transmission is increased. Therefore, aspects of this disclosure relate to a system for presenting transformed data, such as an advertisement or notification, to a customer during a transaction which may include an optimization computer, a repository database which may store one or more transmissions, including advertisements, notifications, and other transformed data and information regarding a particular audience to which the respective transmissions should be presented and a computer system configured to allow transmissions to be uploaded to the repository database. The advertisement may be presented at a point of transaction wherein the transaction is being conducted and the transaction data from the transaction being conducted at the point of transaction may be determined at the point of transaction and may be transmitted to the optimization computer. Further, the optimization computer may compare the transaction data with the information regarding a particular audience to which the respective advertisements should be presented and may select an advertisement to be presented during the transaction based on the comparison of the transaction data with the information regarding a particular audience to which the respective advertisements should be presented. Further, the advertisement optimization computer may retrieve the selected advertisement from the repository database and may transmit the selected advertisement to the point of transaction. Further, the optimization computer may electronically receive data from a database storing customer profile information including: an account balance of a deposit account held with a bank, transaction history associated with the deposit account and data related to a level of income of the customer.

Additional aspects of the disclosure relate to a computer assisted method for presenting an advertisement to a customer during a financial transaction which may include selecting an advertisement to be presented to a customer during a financial transaction at a point of transaction by electronically receiving at an advertisement optimization computer, financial transaction data regarding the financial transaction conducted at the point of transaction, and using the advertisement optimization computer to determine which advertisement to select from an advertisement repository database which stores advertisements that have been uploaded to the advertisement repository database through a computer system configured to allow advertisements to be uploaded to the advertisement repository database. The computer assisted method may further include electronically retrieving the selected advertisement from the advertisement repository database, electronically transmitting the selected advertisement to the point of transaction and electronically displaying the selected advertisement at the point of transaction during the financial transaction. Further, the advertisement optimization computer may electronically receive data from a database storing customer profile information including: an account balance of a deposit account held with a bank, financial transaction history associated with the deposit account and data related to a level of income of the customer.

Further, the advertisement repository database may store information regarding a particular audience to which the respective advertisements should be presented. Further, the financial transaction data from the financial transaction being conducted at the point of transaction may be determined at the point of transaction and transmitted to the advertisement optimization computer. Further, the advertisement optimization computer may compare the financial transaction data with the information regarding a particular audience to which the respective advertisements should be presented and may select an advertisement to be presented during the financial transaction based on the comparison of the financial transaction data with the information regarding a particular audience to which the respective advertisements should be presented.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a diagram of a general-purpose digital computing environment in which certain aspects of the present disclosure may be implemented;

FIG. 2 is a diagram of an illustrative example of an advertising system according to at least one aspect of the present disclosure;

FIG. 3 is a flowchart of an illustrative method for presenting an advertisement to a customer conducting a transaction according to at least one aspect of the present disclosure;

FIG. 4 is a flowchart of an illustrative method for participating in an advertising system according to at least one aspect of the present disclosure;

FIG. 5 is a screen shot of one feature of an advertising system according to at least one aspect of the present disclosure;

FIG. 6 is a screen shot of one feature of an advertising system according to at least one aspect of the present disclosure; and

FIG. 7 is a flowchart of an illustrative method for selecting an advertisement to be presented to a customer conducting a transaction according to at least one aspect of the present disclosure.

### DETAILED DESCRIPTION

In the following description of the various embodiments, reference is made to the accompanying drawings, which form a part hereof, and in which is shown by way of illustration various embodiments in which the disclosure may be practiced. It is to be understood that other embodiments may be utilized and structural and functional modifications may be made.

It is noted that throughout the disclosure, the term bank may be used interchangeably with organization, financial institution, business, etc. The term bank is not intended to be limiting, but rather merely describes a potential embodiment of the disclosure.

Aspects of this disclosure relate to a system and method for transmitting transformed data, such as advertisements, notifications, and the like. Further, particular aspects of this disclosure relate to a system and method for presenting an advertisement to a customer during a transaction. When a customer is conducting a transaction (e.g., a financial transaction) the customer may be a captive audience. Therefore, such a situation presents an opportunity to provide effective advertising to a customer. It would be advantageous for an advertiser to use such an opportunity to advertise a product or service to the customer.

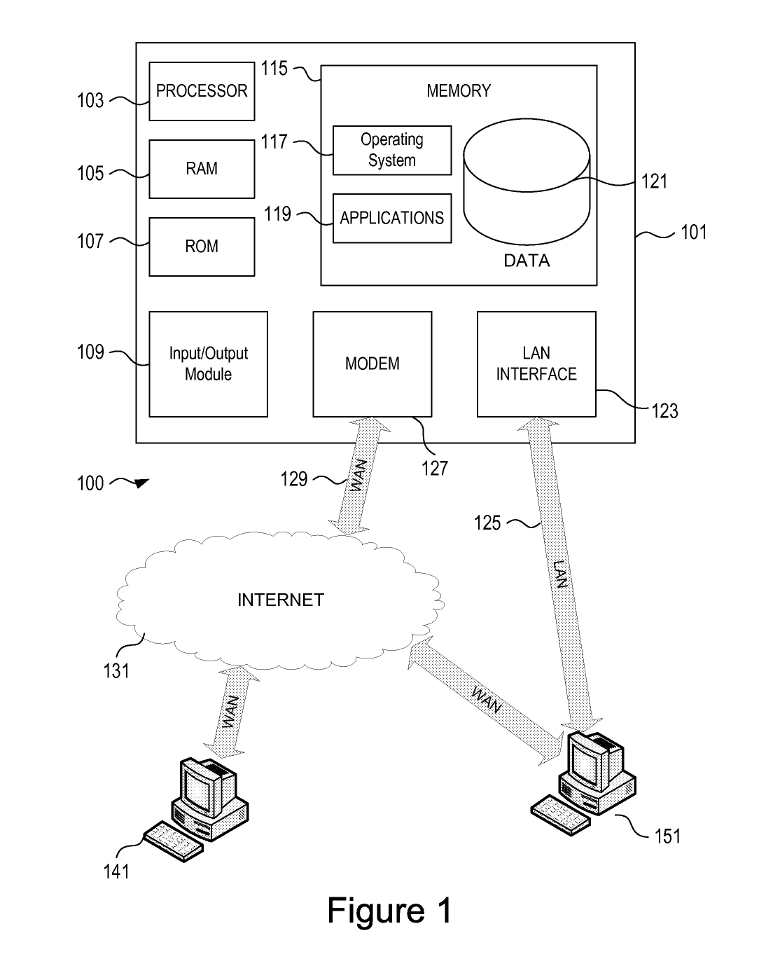

FIG. 1 illustrates an example of a suitable computing system environment 100 that may be used according to one or more illustrative embodiments of the disclosure. The computing system environment 100 is only one example of a suitable computing environment and is not intended to suggest any limitation as to the scope of use or functionality of the disclosure. Neither should the computing system environment 100 be interpreted as having any dependency nor requirement relating to any one or combination of components illustrated in the exemplary computing system environment 100.

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, etc. that perform particular tasks or implement particular abstract data types. The disclosure may also be practiced in distributed computing environments where tasks are performed by remote processing devices that are linked through a communications network. In a distributed computing environment, program modules may be located in both local and remote computer storage media including memory storage devices.

With reference to FIG. 1, the computing system environment 100 may include a computer 101 having a processor 103 for controlling overall operation of the computer 101 and its associated components, including RAM 105, ROM 107, input/output module 109, and memory 115. Computer 101 typically includes a variety of computer readable media. Computer readable media may be any available media that may be accessed by computer 101 and include both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 101. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. Although not shown, RAM 105 may include one or more are applications representing the application data stored in RAM memory 105 while the computer is on and corresponding software applications (e.g., software tasks), are running on the computer 101.

Input/output module 109 may include a microphone, keypad, touch screen, and/or stylus through which a user of computer 101 may provide input, and may also include one or more of a speaker for providing audio output and a video display device for providing textual, audiovisual and/or graphical output. Software may be stored within memory 115 and/or storage to provide instructions to processor 103 for enabling computer 101 to perform various functions. For example, memory 115 may store software used by the computer 101, such as an operating system 117, application programs 119, and an associated database 121.

Alternatively, some or all of computer 101's computer executable instructions may be embodied in hardware or firmware (not shown). As described in detail below, the database 121 may provide centralized storage of account information and account holder information for the entire business, allowing interoperability between different elements of the business residing at different physical locations.

Computer 101 may operate in a networked environment supporting connections to one or more remote computers, such as branch terminals 141 and 151. The branch computers 141 and 151 may be personal computers or servers that include many or all of the elements described above relative to the computer 101. The network connections depicted in FIG. 1 include a local area network (LAN) 125 and a wide area network (WAN) 129, but may also include other networks. When used in a LAN networking environment, computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are exemplary and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program 119 used by the computer 101 according to an illustrative embodiment of the disclosure may include computer executable instructions for invoking user functionality related to communication, such as email, short message service (SMS), and voice input and speech recognition applications.

Terminals 141 or 151 may also be mobile terminals including various other components, such as a battery, speaker, and antennas (not shown). Input/output module 109 may include a user interface including such physical components as a voice interface, one or more arrow keys, joystick, data glove, mouse, roller ball, touch screen, or the like.

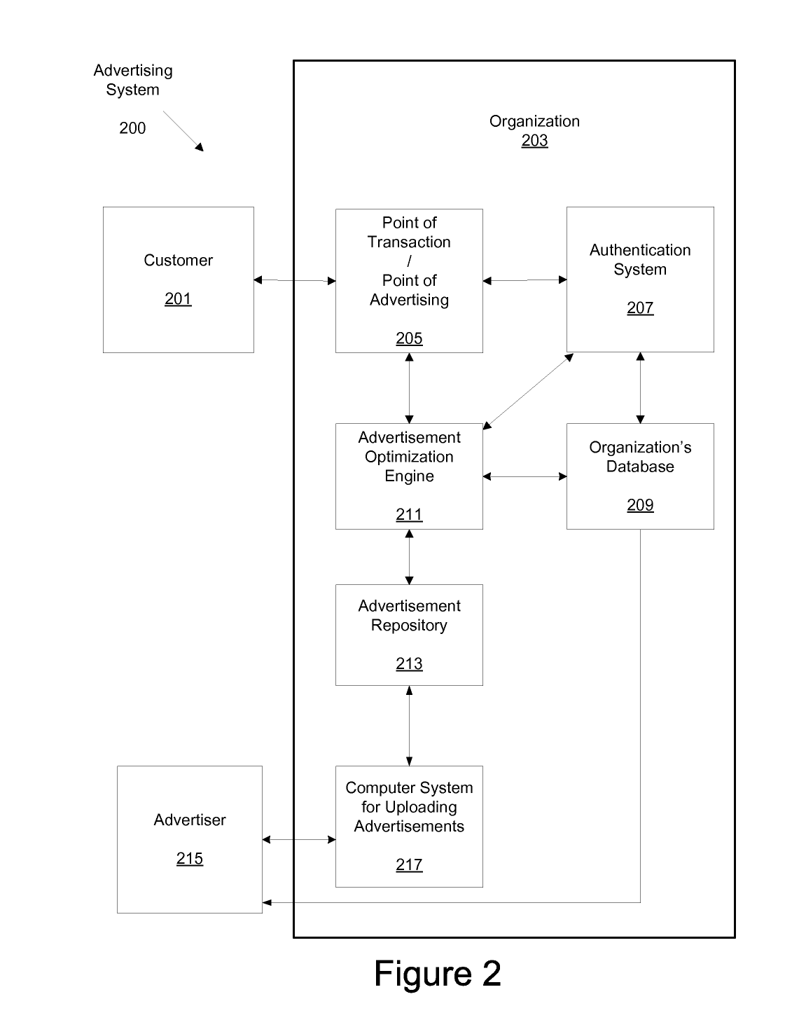

FIG. 2 is a diagram which shows an illustrative advertising system 200 according to aspects of this disclosure. As seen in FIG. 2, a customer 201 conducts a transaction with an organization 203 at a point of sale/point of advertising 205. According to aspects of this disclosure, the customer 201 may have to authenticate their identity in order to conduct the transaction. Therefore, as seen in FIG. 2, the advertising system 200 may include an authentication system 207. The authentication system 207 may transmit data to and receive data from one or more of the organization's databases 209. Further, according to aspects of the disclosure, that advertising system 200 may includes an advertisement optimization computer, or engine, 211 and advertisement repository database 213. As seen in FIG. 2, the advertisement optimization engine 211 may transmit data to and receive data from: a point of sale/point of advertising 205, the authentication system 207, one or more of the organization's databases 209, and the advertisement repository 213.

Further, according to aspects of the disclosure, an advertiser 215 may upload an advertisement into a computer system 217 for receiving and transmitting advertisements. It is noted that according to aspects of this disclosure, the computer system 217 may be a web based system. According to aspects of this disclosure, the computer system 217 may transmit data to and receive data from the advertisement repository 213. The above described advertising system 200 represented in FIG. 2 will be described in more detail below. However, it is noted here that one or more of the elements in the above described advertising system 200 (e.g., point of transaction 205, authentication system 207, database 209, advertisement optimization engine 211, advertisement repository 213, computer system 217) may include a computer system with a processor, a memory or both.

According to aspects of this disclosure, during the transaction described above, an advertisement may be presented to the customer 201. Further, it is noted that according to aspects of the disclosure, the above described transaction may be financial transaction. For example, according to aspects of the disclosure, the transaction may be a financial transaction conducted at an Automated Teller Machine (ATM). For example, according to one aspect of the disclosure, if a customer 201 is making a transaction at the ATM, such as a withdrawal, a deposit, a balance inquiry, a transfer of funds, etc., the advertisement could be presented to the customer 201 while the transaction is being processed. For example, once the customer 201 has entered the information required in order for the transaction to be processed (e.g., a Personal Identification Number (PIN), the amount of funds involved in the transaction, etc.), but before the transaction has been completed, there may be a time period during which the transaction is being processed. During such a time period it is likely the customer 201 is paying attention to the ATM (e.g., the customer 201 may be waiting for confirmation that the transaction has been approved and completed). This time period during which the customer 201 is paying attention to the ATM may be an opportune time for presenting the advertisement, because the customer 201 may be a captive audience who must wait until the transaction is completed and receive confirmation from the ATM that the transaction is complete.

According to aspects of this disclosure, the advertisement presented to the customer during the transaction could be a visual advertisement displayed on the screen of the ATM. According to other aspects of the disclosure, the advertisement could be an audio advertisement played through the audio system of the ATM. According to still other aspects of the disclosure, the advertisement could combine both audio and visual aspects.

According to aspects of this disclosure, the advertising system 200 may provide the customer 201 an opportunity to get further details about advertisement or the product or service to which the advertisement relates. For example, if the customer 201 wants to get further details about advertisement (or, for example, a coupon related to the advertisement) the customer 201 may have the opportunity to press a button on the ATM (or use a voice recognition system, etc., to communicate the point of transaction 205) to have more information about the advertisement presented (e.g., displayed on the screen, played throughout the audio system, printed out via the ATM's printing system) or sent to the customer (e.g., via mail, email, messaging service (SMS, MMS), etc.). For example, according to aspects of this disclosure, the bank could use address information stored on the ATM card in order to have additional information about the advertisement sent to the customer 201. Also, according to aspects of this disclosure, if the bank already has the customer's contact information, e.g., an email address or phone number (e.g., if the customer 201 is a member of the particular bank that owns the ATM, then the bank may already have such contact information stored in a customer's profile), then the bank may use such customer's contact information in order to have additional information about the advertisement sent to the customer 201. Of course, advertising system 200 may also configure the ATM to allow the customer 201 to enter such contact information into the ATM (e.g., via the ATM keypad or voice recognition service).

According to aspects of this disclosure, alternatively, or in addition to an advertisement being displayed during the actual processing of the transaction, an advertisement may be presented to the customer 201 before and/or after the transaction. For example, the ATM may contain a motion or proximity sensor that determines if a customer 201 approaches the ATM to make a transaction. In response to the sensor's readings, the ATM may automatically present the advertisement. According to another aspect of the disclosure, once the customer 201 has entered their ATM card into the ATM, the advertising system 200 may present a customer 201 with the advertisement prior to continuing on to conducting the transaction (e.g., the customer 201 may be required to view an advertisement, or asked if they wish to view an advertisement, prior to entering a PIN to authenticate and conduct the transaction). According to another aspect of the disclosure, the advertisement may be presented to the customer 201 after the customer 201 has completed the transaction. For example, upon completing the transaction, but prior to returning the customer's ATM card, the advertising system may present a customer 201 with the advertisement (e.g., the customer 201 may be required to view an advertisement, or asked if they wish to view an advertisement).

According to other aspects of the disclosure, the point of transaction 205 may be at a banking center. For example, the point of transaction may be a banking counter at a branch of the bank. In such a situation, the advertisement may be presented on a screen (e.g., an interactive touch screen monitor) in the banking center in the proximity of banking counter (e.g. next to a window of a bank teller with whom the customer 201 is conducting the transaction). According to aspects of the disclosure, an audio system or printer may also be included if desired.

In such an embodiment, the advertisement may be presented to the customer 201 before, during or after a transaction conducted at the banking counter as described above. The details of presenting the advertisement to the customer 201 would be similar to the previously described embodiment and, therefore, will not be elaborated on here for the sake of brevity. According to aspects of the disclosure, alternatively, or in addition to the screen in the banking center, the advertisement may also be presented on a shifting or electronic billboard in the banking center.

According to other aspects of the disclosure, the transaction may be an online transaction. In such a situation, the point of transaction 205 may be a personal computer (or smart phone) which the customer 201 is using to conduct the transaction. In such an embodiment, the advertisement may be presented on a screen of the personal computer and/or the audio system of the personal computer. In such an embodiment, the advertisement may be presented to the customer 201 before, during or after a transaction conducted at the personal computer as described above. The details of presenting the advertisement to the customer 201 would be similar to the previously described embodiment and, therefore, will not be elaborated on here for the sake of brevity.

According to other aspects of the disclosure, the transaction may be conducted via a telephone. In such a case, the point of transaction 205 may be through a customer service agent or account manager with whom the customer 201 is talking. In such an embodiment, the advertisement may be presented on a screen of a personal computer on which customer service agent or account manager is using to assist the customer 201 conduct the transaction. In such an embodiment, the advertisement may be presented to the customer 201 before, during or after a transaction conducted over the phone through the customer service agent or account manager. In other words, the customer 201 service agent or account manager would read the advertisement on the screen and vocally convey it to the customer 201. The other details of presenting the advertisement to the customer 201 would be similar to the previously described embodiment (however, may be done through the customer service agent or account manager and their personal computer) and, therefore, will not be elaborated on here for the sake of brevity.

Regardless of type of point of transaction at which the customer 201 conducting the transaction, according to aspects of this disclosure, and as will be discussed in detail below, the point of transaction 205 may transmit data regarding the transaction to the advertisement optimization engine 211. Such transaction data may include the type of transaction (e.g., withdrawal, deposit, balance inquiry, transfer of funds, etc.), the type of point of transaction 205 at which the transaction is being conducted (e.g., ATM, counter transaction, online transaction, telephone transaction, etc.), the location of the point of the transaction 205, the date of the transaction, and time of the transaction, the amount of funds involved in the transaction, etc. According to aspects of the disclosure, the advertisement optimization engine 211 may leverage such information in order to select the particular advertisement to be presented to the customer 201. For example, according to aspects of this disclosure, once the transaction data has been submitted to the advertisement optimization engine 211, the advertisement optimization engine 211 may compare such transaction data with the advertisements stored in the advertisement repository 213 in order to present the customer 201 with an advertisement that is likely to interest the customer 201 (this process will be described in detail below). In such a way, the likelihood of effective advertising is increased.

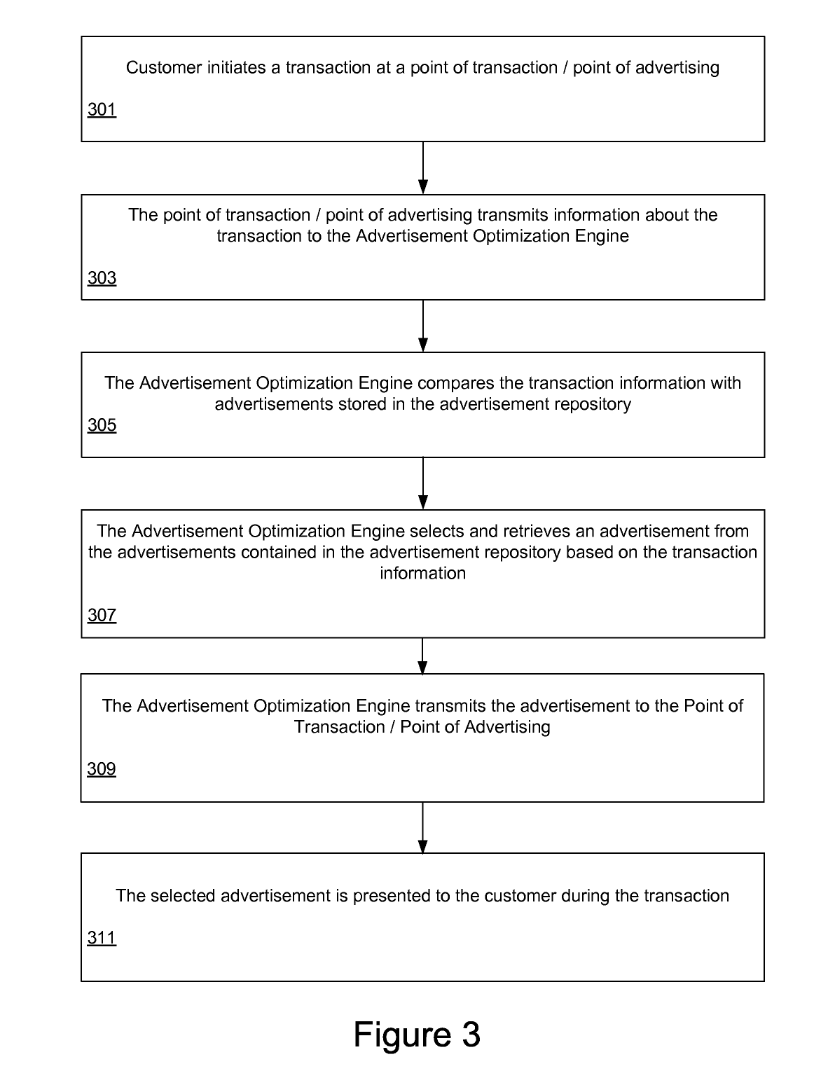

FIG. 3 is a flow chart which demonstrates an illustrative method for presenting an advertisement to a customer during a transaction according to an aspect of the disclosure. As seen in FIG. 3, in step 301 a customer 201 initiates a transaction at a point of transaction/point of advertising 205. In step 303, the point of transaction 205 transmits information regarding the transaction to the advertisement optimization engine 211. In step 305, the advertisement optimization engine 211 compares the transaction information with advertisements stored in the advertisement repository 213. In step 307, the advertisement optimization engine 211 selects and retrieves an advertisement from the advertisements stored in the advertisement repository 213 based on the transaction information. In step 309, the advertisement optimization engine 211 transmits the advertisement to the point of transaction/point of advertising 205. In step 311, the point of transaction/point of advertising 205 presents the advertisement to the customer during the transaction.

As discussed above, according to aspects of this disclosure, the user may need to be authenticated in order to conduct the transaction. For example, according to aspects of this disclosure, and as shown in FIG. 2, the advertising system 200 may include an authentication system 207. The authentication system 207 may use a variety of different methods for authenticating the identity of the customer 201. Further, the particular method employed may depend on the particular type of point of transaction 205 through which the transaction is being conducted. For example, in an ATM transaction as described above, in order to be authenticated, the customer 201 may be required to insert an ATM card into the ATM and, also, enter a PIN associated with the ATM card using the keypad of the ATM. Once, the customer 201 has been authenticated, the transaction may be conducted. A similar method may then be employed for a transaction conducted at a banking counter, wherein in order to be authenticated, the customer 201 may be required to swipe an ATM card through a card reader and, also, enter a PIN associated with the ATM card using the keypad of the card reader. According to other aspects of this disclosure, a similar method may be employed for conducting an online transaction. In such an embodiment, in order to be authenticated, the customer 201 may be required to enter an identification number (e.g., a social security number) and a password in order to conduct the transaction. According to other aspects of this disclosure, a similar method may be employed for conducting a telephone transaction. In such an embodiment, in order to be authenticated, the customer 201 may be required to provide the customer service agent or account manage with the identification number and a password in order to conduct the transaction.

According to aspects of this disclosure, other methods of authenticating the user may be used alternatively or, in addition to, the methods described above. For example, according to aspects of this disclosure, biometrics may be used to authenticate a customer 201. For example, biometric authenticating devices, such as retinal scanners, fingerprint scanners, facial recognition cameras, voice authentication audio systems, etc. may be employed in one or more of the above described points of transaction in order to authenticate the customer 201 conducting the transaction.

Regardless of the method employed to authenticate the customer 201 conducting the transaction, according to aspects of this disclosure, and as will be discussed in detail below, information from the authentication may be leveraged in order to select the particular advertisement to be presented to the customer 201. For example, according to aspects of this disclosure, and as seen in FIG. 2, once the customer 201 has been authenticated, the authentication system 207 may transmit data regarding the authentication to the advertisement optimization engine 211 and organization's databases 209. Further, the databases 209 could leverage such information from the authentication to provide the advertisement optimization engine 211 with data regarding the identity of customer 201 and other customer profile information. The advertisement optimization engine 211 may leverage such data including information regarding the identity of customer 201 and other customer profile information in order to present the customer 201 with an advertisement that is likely to interest the customer 201. In such a way, the likelihood of effective advertising is increased. Such aspects of such advertising system 200 will be discussed in detail below.

According to aspects of the disclosure, the advertising system 200 may include a computer system 217 through which advertisers 215 may submit advertisements. For example, according to one embodiment of the disclosure, the advertising system 200 may include a web based system 217 through which advertisers 215 may upload advertisements to be used in the advertising system 200. The web based system 217 may provide several advantages to the advertisers 215 who participate in the advertising system 200. Aspects of this web based system 217 will be described in detail below.

According to aspects of this disclosure, in order for an advertiser 215 to participate in the advertising system 200, the advertiser 215 may be required to register with the organization 203. For example, according to aspects of this disclosure, the advertiser 215 may have to submit particular information to the organization 203 and then be approved by the organization 203 in order to participate in the advertising system 200.

According to an embodiment of the disclosure, wherein the organization 203 is a bank, and the advertiser 215 is a merchant, the merchant may have to become a customer 201 of the bank, create an account with the bank (e.g., a deposit account), provide particular information to the bank, such as contact information, location(s) at which the merchant in located, financial information (e.g., commercial value of the merchant, amount of funds in the merchant's one or more deposit accounts with the bank), etc.

According to aspects of this disclosure, if an advertiser 215 registers with the organization 203, is approved, and becomes an advertiser 215 who is allowed to participate in the advertising system 200, then the advertiser 215 may be allowed to create an advertising account associated with the web based system 217. The advertising account may include several features, such as described below.

Initially, it is noted, that the advertising account may include an authentication system that allows the advertiser 215 to access the advertising account. For example, according to aspects of the disclosure, the advertiser 215 may access the advertising account from personal computer, smart phone, etc. using providing an identification number and password. Of course, other methods of authenticating the advertiser 215 (e.g., other authentication methods described above) may be used as well.

Once the advertiser 215 has accessed the advertising account, the advertiser 215 may upload the advertisement to advertising account in the advertising system 200. For example, according to aspects of this disclosure, the advertisements 200 may already be in an electronic format (e.g., Protected Document Format (PDF)) and may be uploaded to the advertising account. Once the advertisement has been uploaded to the advertising account, the advertiser 215 may have an opportunity to store the advertisement in the advertising account prior to submitting the advertisement to the organization 203 for use in the advertising system 200.

According to aspects of this disclosure, once the advertisement is submitted to the organization 203 for use in the advertising system 200, the organization 203 may review the advertisement and determine whether the advertisement is acceptable for use in the advertising system 200. For example, the organization 203 may be notified that an advertisement from a particular advertising account has been submitted for approval (e.g., via an automatic email that is generated and transmitted to the organization upon the advertiser 215 submitting an uploaded advertisement for review by the organization 207). The organization 203 may then review the advertisement to determine whether the advertisement is appropriate (e.g., that the advertisement is not offensive), free of mistakes (e.g., provides the merchant's information correctly), conforms to formats that may be required by the advertising system 200 (e.g., dimensions of the advertisement, quality of the image, etc.), etc. If the advertisement is approved by the organization 203, then the advertisement may be transmitted to the advertisement repository 213 and the advertiser 215 may be notified by the organization 203 of the approval (e.g., an email may be sent to the advertiser's advertising account).

As discussed above, once the advertisement has been approved by the organization 203, the advertisement may be transmitted to the advertisement repository 213. The advertisement repository 213 may be a database which stores the approved advertisements from the advertisers 215. Further, the advertisement repository 213 may also store information associated with respective advertisements as will be discussed in detail below. As seen in FIG. 2, the advertisement optimization engine 211 may examine data (e.g., a particular advertisement and/or information associated with the advertisement) in the advertisement repository 213 in order to select an advertisement to be transmitted to the point of transaction 205. Further, the advertisement optimization engine 211 may then retrieve a selected advertisement from the advertisement repository 213 and transmit it to the point of transaction 205 to be presented to a customer 201 during a transaction. According to aspects of the disclosure, the particular advertisement retrieved from the advertisement repository 213 by the advertisement optimization engine 211 may be dependent of various factors, as will be discussed in detail below. It is noted that according to aspects of this disclosure, the advertisements in the advertisement repository 213 may be removed from the advertisement repository 213 upon particular circumstances. For example, the merchant may request the advertisements be removed from the advertisement repository 213, the advertisements may include data associated with the advertisement which instructs the advertising system 200 to remove the advertisement from the advertisement repository 213 upon a certain date (e.g., when the advertisement would expire), etc.

According to aspects of the disclosure, the advertising system 200 may determine information about the transaction conducted at the point of transaction 205 and, further, may transmit such information to the organizations databases 209 to be stored. Further, according to aspects of the disclosure, the advertising system 200 can determine information about the presentation of the advertisement to the customer 201 during the transaction. Further, such information may be also transmitted to and stored in the organizations databases 209. As will be described below, according to aspects of this disclosure, such information regarding the transaction itself and the presentation of the advertisement to the customer 201 during the transaction may be provided to the advertiser 215 as a value added service. The advertiser 215 may be able to leverage such information provided by the advertising system 200 to analyze the effectiveness of their advertisements and potentially modify their advertising strategy.

According to aspects of the disclosure, the advertising system 200 may determine information about a transaction that was conducted including: the type of transaction conducted, the type of point of transaction through which the transaction was conducted, the date the transaction was conducted, the time the transaction was conducted, the location at which the transaction was conducted, the length of time over which the transaction was conducted, the amount of funds involved in the transaction, etc. For example, according to one embodiment of this disclosure, the transaction may have been conducted at an ATM. The point of transaction 205 (in this case the ATM) may transmit such information to the organization's database 209. The database 209 may store such information. Further, according to aspects of the disclosure, the advertising system 200 may determine and store data regarding how frequently an advertisement was presented to customers. For example, according to aspects of the disclosure, each time an advertisement is presented to a customer 201 during a transaction with the advertising system 200, the organization's database 209 may receive data from the advertisement optimization engine 211 and the point of transaction 205 regarding which advertisement was selected from the advertisement repository 213 to be presented to the customer 201 during the transaction. Such information may be stored in the organization's database 209.

According to aspects of the disclosure, the advertising system 200 may determine further information about the presentation of the advertisement to the customer 201 during the transaction. For example, according to aspects of the disclosure, the advertising system 200 may determine if the customer 201 inquired about further information regarding the advertisement. For example, in the embodiment relating to a transaction conducted at an ATM, according to aspects of the disclosure, the advertising system 200 may have presented an advertisement that allowed the customer 201 to view or hear more information by pushing a button the ATM. In such an embodiment, if customer 201 pressed the button to learn more about the advertisement, then such information may be transmitted back to the organization's database 209 to the stored. Further, if the advertisement had multiple screens such that the customer 201 would have to press the button on the ATM several times in order to view the entire advertisement, such information about whether a portion or the entire advertisement have been viewed may be transmitted back to the organizations database 209 to the stored. Similarly, in a situation wherein the customer 201 requested more information about the advertisement to be sent to the customer 201 (e.g., via information being printed at the ATM, mailed to the user through regular mail, email, SMS, etc.) (or, in the case, wherein a coupon is associated with the advertisement, the customer 201 requested the coupon) such information could also be may be transmitted back to the organization's database 209 to be stored.

According to aspects of the disclosure, the advertising system 200 may determine further information about the presentation of the advertisement to the customer 201 during the transaction. For example, according to aspects of the disclosure, the advertising system 200 may determine how long the customer 201 viewed the advertisement. For example, in the embodiment relating to a transaction conducted at an ATM, according to aspects of the disclosure, the advertising system 200 may have presented an advertisement that allowed the customer 201 to skip over the advertisement by pushing a button the ATM. In such an embodiment, if customer 201 pressed the button to skip over the advertisement, then such information may be transmitted to the organization's database 209 to the stored. Further, if the customer 201 paid attention to a portion of the advertisement before deciding to skip the advertisement, such information about the portion of the advertisement and the length of time associated with it may be stored and transmitted back to the organization's database to the stored. It is noted that a real clock time may be included in the system and used to calculate the length of time.

As described above, according to aspects of this disclosure, transactions conducted at a point of transaction 205, such as transaction conducted at a banking center (e.g., at a banking counter), online, over a telephone, etc. may determine the same information about the transaction and the presentation of the advertisement to the customer in a similar manner to that described above. Further, such information about the transaction (e.g., type of transaction, type of point of transaction, date, time, location, the length of time over which the transaction was conducted, the amount of funds involved in the transaction, etc.) and about the presentation of the advertisement to the customer during the transaction (e.g., how many times the advertisement was retrieved by the advertisement optimization engine 211 to be presented, if the customer 201 requested further information at the point of the transaction 205, if the customer 201 requested further information be sent to them (e.g., via information being printed at the point of transaction, mailed to the user through regular mail, email, SMS, etc.), if the customer 201 requested a coupon, if the customer 201 paid attention to a portion or the entirety of the advertisement, etc.) may be transmitted to the organization's database 209 to be stored in a manner such as described above. The details of obtaining the information about the transaction and the information about the presentation of the advertisement during the transaction would be similar to the previously described embodiment and, therefore, will not be elaborated on here for the sake of brevity.

Once the information about the transaction (e.g., type of transaction, type of point of transaction, date, time, location, the length of time over which the transaction was conducted, amount of the funds involved in the transaction, etc.) and about the presentation of the advertisement during the transaction (e.g., how many times the advertisement was retrieved by the advertisement optimization engine 211 to be presented, if the customer 201 requested further information at the point of the transaction, if the customer 201 requested further information be sent to them (e.g., via information being printed at the point of transaction, mailed to the user through regular mail, email, SMS, etc.), if the customer 201 requested a coupon, if the customer 201 paid attention to a portion or the entirety of the advertisement, etc.) has stored in the organization's database 209, then, as seen in FIG. 2, the information may be transmitted to the advertiser 215 of the particular advertisement. For example, according to aspects of the disclosure, the information may be transmitted to the particular advertiser's advertising account (e.g., via email or other electronic transmissions).

The above described information about the transaction and about the presentation the advertisement 215 to the customer during the transaction may be useful to the advertiser 215. The advertiser 215 may analyze the information to determine many aspects related to the effectiveness of the advertisement. For example, if the advertisement is more effective in particular location, during a particular time of day, or time of the year or month, if a particular advertisement is viewed for a longer amount of time or by a larger group of people than a second of the advertiser's advertisement, etc. The advertiser 215 could then leverage such information in order to determine if the advertiser 215 should consider modifying one or more of their advertisements or their entire advertising campaign in order to increase its effectiveness.

It is noted, in the situation wherein a customer 201 of the transaction obtains a coupon from the advertisement (e.g., if a coupon is emailed, sent via SMS, or printed at the point of the transaction) through the advertising system 200, according to aspects of the disclosure, an identifier of the point of the transaction that provided the coupon (along with other data, e.g., the date and time of the transaction) may be embedded in the coupon. For example, in an ATM transaction wherein the customer 201 requests for the coupon to be sent to their phone via SMS (or printed at the ATM via the ATM's printing system), then the coupon may include an alphanumerical code, data glyph, bar code, etc. which contains the information such as, the location of the transaction wherein the advertisement was presented (e.g., a location of an ATM), the date and time of the transaction, etc. Therefore, when that coupon is used for a purchase and the coupon is returned to the advertiser 215, the advertiser 215 will be able obtain valuable information from the coupon. In other words, according to aspects of the disclosure, when coupons obtained from advertisements presented via the advertising system 200, are actually used for purchase and returned to the advertiser 215, the advertiser 215 will be able to determine, first, that the advertising was effective because the coupon was actually obtained and used in making a purchase related to the advertising, and, additionally, details about the transaction during which the effective advertising was presented to the customer 201, such as the location at which the effective advertising was presented; the date and time of the transaction, etc. The advertiser 215 could then leverage such information in order to determine if the advertiser 215 should consider modifying one or more of their advertisements or their entire advertising campaign in order to increase its effectiveness.

According to aspects of the disclosure, the organization 203 may charge the advertiser 215: a fee for participating in the advertising system 200, a fee for each advertisement submitted, etc. According to aspects of the disclosure, the advertising account of an advertiser 215 may be electronically linked with a financial account that the advertiser 215 has with the organization 203 (e.g., a deposit account). Therefore, the fees for the advertising may be directly withdrawn from the financial account associated with the advertising account of the advertiser 215. It is noted, or course, that in other embodiments the advertiser 215 may simply be billed (e.g., via mail) for the fees associated with advertising the advertisement.

According to aspects of the disclosure, the organization 203 may charge the advertiser 215 a fee for each time an advertisement is presented to a customer 201. As described above, according to aspects of the disclosure, the advertising system 200 may determine and store data regarding how frequently an advertisement was presented to customers. Further, such information may be leveraged by the organization 205 to charge the advertiser 215 of the particular advertisement for each time the advertisement was presented to a customer 201 with the advertising system 200. Therefore, as described above, since the financial account is associated with the advertising account, the fees for the advertising may be directly withdrawn from the financial account associated with the advertising account of the advertiser 215. Such a feature of the advertising system 200 may be particularly advantageous for the organization 203 because the organization 203 would know precisely how many times the advertisements are being presented and can determine how best to charge fee to the advertisers 215 for participating in the advertising system 200 (e.g., a flat fee, a fee for each advertisement submitted, a fee for each presentation of the advertisement).

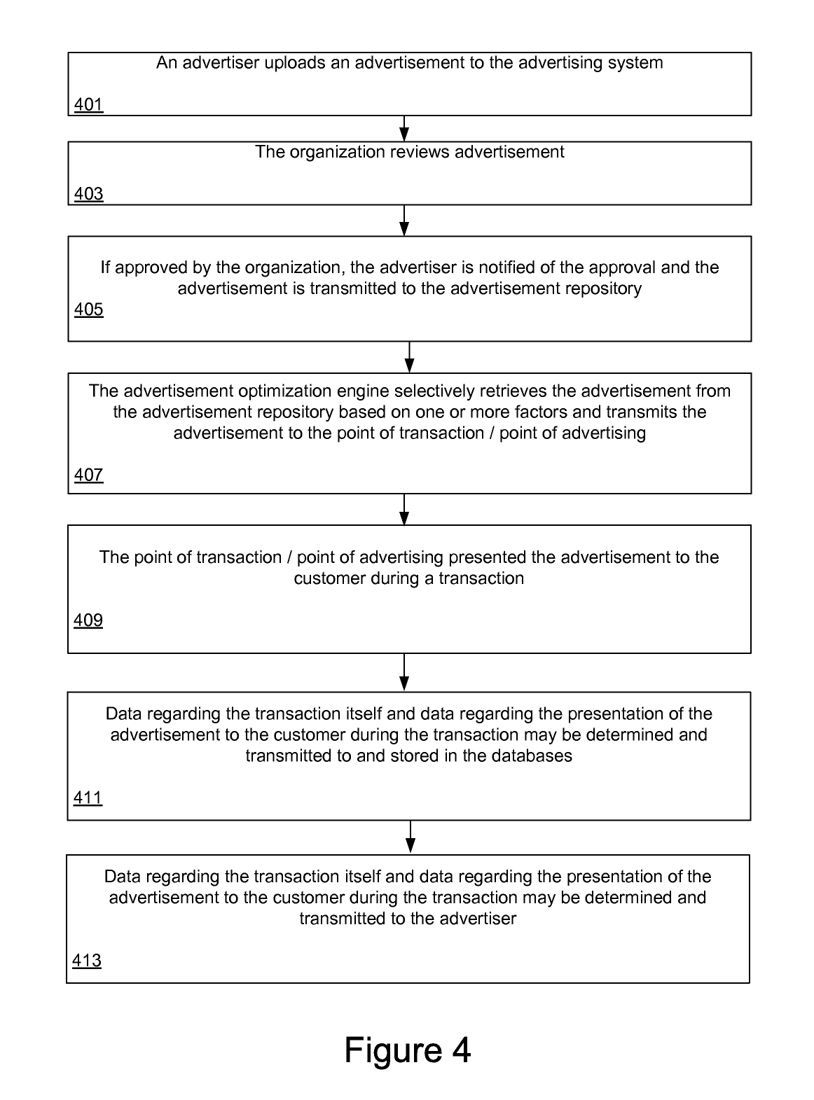

FIG. 4 is a flow chart which demonstrates an illustrative method for participating in an advertising system according to an aspect of the disclosure. As seen in FIG. 4, in step 401 an advertiser 215 uploads an advertisement. In step 403, the organization 203 reviews the advertisement. In step 405, if the advertisement is approved, the advertiser 215 is notified of the approval and the advertisement is transmitted to the advertisement repository 213. In step 407, the advertisement optimization engine 211 selectively retrieves the advertisement from the advertisement repository 213 based on one or more factors and transmits the advertisement to the point of transaction/point of advertising 205. In step 409, the point of transaction/point of advertising 205 presents the advertisement to the customer during the transaction. In step 411, data regarding the transaction itself and the presentation of the advertisement to the customer during the transaction is determined and transmitted to and stored in the databases. In step 413, data regarding the transaction itself and the presentation of the advertisement to the customer during the transaction is transmitted to the advertiser 215.

As will be understood from the above description, the advertising system 200 provides several benefits for the advertisers 215 who participate in the advertising system 200. For example, according to aspects of the disclosure, the advertising system 200 includes a web based system 217 wherein advertisers 215 can easily and conveniently create advertisements and have them advertised to potential customers. Further, the advertising system 200 provides the advertisers 215 with ability to quickly create advertisements and have them presented to potential customers within a short time period. Additionally, according to aspects of the disclosure, the advertising system 200 may also provide the advertisers 215 with the ability to quickly cease the advertisements. For example, according to aspects of the disclosure, the advertisers 215 may withdraw an advertisement from the advertisement repository 213 immediately upon accessing their advertising account. Further, according to aspects of the disclosure, the advertisers 215 may set a limit on the amount of advertisements or coupons that may be presented by the advertising system 200. It is noted that, according to aspects of this disclosure, the advertising system 200 is able to determine that amount of times the advertisement has been presented and the amount of coupons that have been presented and will cease presenting them once the predefined limit has been reached.

Further, it is noted that aspects of the advertising system 200 may be especially beneficial for small business owners/merchants who have limited advertising budgets. For example, the small business may be able quickly and efficient create an advertisement, upload the advertisement to the advertising system 200, and have the advertisement presented to potential customers without incurring the relatively large expense that may be associated with traditional marketing campaigns.

Further, another benefit of the advertising system 200 is that it may provide feedback to the advertiser 215 on the effectiveness of the advertisement. For example, as described above, the advertising system 200 can record data about the transaction and about the presentation of the advertisement 215 during the transaction. The information may be transmitted to the advertiser 215 so that the advertiser 215 may analyze the information to determine many aspects related to the effectiveness of the advertisement.

Another benefit of the advertising system 200 as will be described in detail below is that aspects of the advertising system 200 allow the advertisers 215 who participate in the advertising system 200 to be able to focus their advertising to target particular audiences. It is noted that generally, advertising is more effective when it is targeted to an audience that is likely to be interested in the product or service that is being advertised. For example, if a particular product or service is advertised to an audience that is unlikely to be interested in that particular product or service, then such advertising will generally be less effective than if that particular product or service is advertised to an audience that is likely to be interested in that particular product or service. Therefore, aspects of the advertising system 200 are directed to an advertisement optimization engine 211 which may increase the effectiveness of an advertisement by presenting the advertisement to an audience that is likely to be interested in that particular product or service.

As discussed above, according to aspects of the disclosure, the advertising system 200 may include an advertisement optimization engine 211. Further, as discussed above, according to aspects of the disclosure, during the transaction, information regarding the transaction itself may be transmitted to the advertising optimization engine 211. Further, as discussed above, according to aspects of the disclosure, during the transaction the user may be authenticated and, according to aspects of the disclosure, during the transaction, information regarding the customer who is conducting the transaction may be transmitted to the advertising optimization engine 211. According to aspects of this disclosure, the advertisement optimization engine 211 may leverage such information in determining which advertisement to display to the customer 201 during a transaction. Such features of the advertising system 200 and the advertisement optimization engine will be described in detail below.

According to aspects of the disclosure, the advertising system 200 may allow the advertiser 215 the ability to selectively present advertisements to customers 201 based on a number of factors which are designed to increase the likelihood that the advertisement will be presented to a customer 201 who is interested in the product or service. For example, according to aspects of the disclosure, the advertising system 200 may allow the advertiser 215 the ability to selectively present advertisements to customers 201 based on the customer's transaction history, age, income level, credit scores, deposit account balance, address information, sex, etc. Further, according to aspects of the disclosure, the advertising system 200 may allow the advertiser 215 the ability to selectively present advertisements to customers 201 based on other factors such as characteristics of the transaction itself (e.g., the type of the transaction, the type of point of transaction through which the transaction is conducted, the date of the transaction, the time of the transaction, the location of the transaction, the location of the transaction in relation to its proximity to one of the advertiser's location, etc.). By allowing the advertiser 215 the ability to selectively target the advertising, aspects of the advertising system 200 may increase the effectiveness of an advertisement by presenting the advertisement to an audience that is likely to be interested in that particular product or service.

According to aspects of the disclosure, the advertising system 200 may include a feature that allows the advertiser 215 to enter characteristics of the intended audience to which the advertiser 215 would like the advertisement displayed. For example, according to aspects of the disclosure, an advertiser's advertising account for submitting advertisements to the organization's advertising system 200 may include features which allow the advertiser 215 to enter characteristics of the intended audience to which the advertiser 215 would like the advertisement displayed. For example, the advertiser's advertising account may be part of a web based system 217 and include fields for the advertiser 215 to enter characteristics of the intended audience to which the advertiser 215 would like the advertisement displayed.

According to aspects of the disclosure, such characteristics of the intended audience may include information regarding the transaction itself. For example, such characteristics regarding the transaction itself may include: the type of transaction being conducted during which the advertisement is to be presented (e.g., withdrawal, deposit, balance inquiry, account transfer), the type of point of transaction through which the transaction is conducted, the location of the point of transaction where the transaction is being conducted, a date range during which the advertisement is to be presented (e.g., November 20-November 28), a range of a time of day during which the advertisement is to be presented (e.g., 7:00 pm. to 3:00 am), the proximity of the point of transaction to one of the merchants location, a range of the amount of funds involved in the transaction, etc.

According to aspects of the disclosure, such characteristics may also include information about the customer 201 who is conducting the transaction. For example, such characteristics about the customer 201 who is conducting the transaction may include: the customer's transaction history, the age range of the customer 201 to which the advertisement is to be presented (e.g., 20-30 year old), the income level range of the customer 201 to which the advertisement is to be presented, the credit score range of the customer 201 to which the advertisement is to be presented, the deposit account balance range of the customer 201 to which the advertisement is to be presented, proximity of the customer's home address or place of employment address to a location of the merchant, sex of the customer, etc.

It is noted that the characteristics the advertiser 215 may choose in order to target the advertising are not limited to the characteristics described above. Instead, the characteristics described above are merely illustrative.

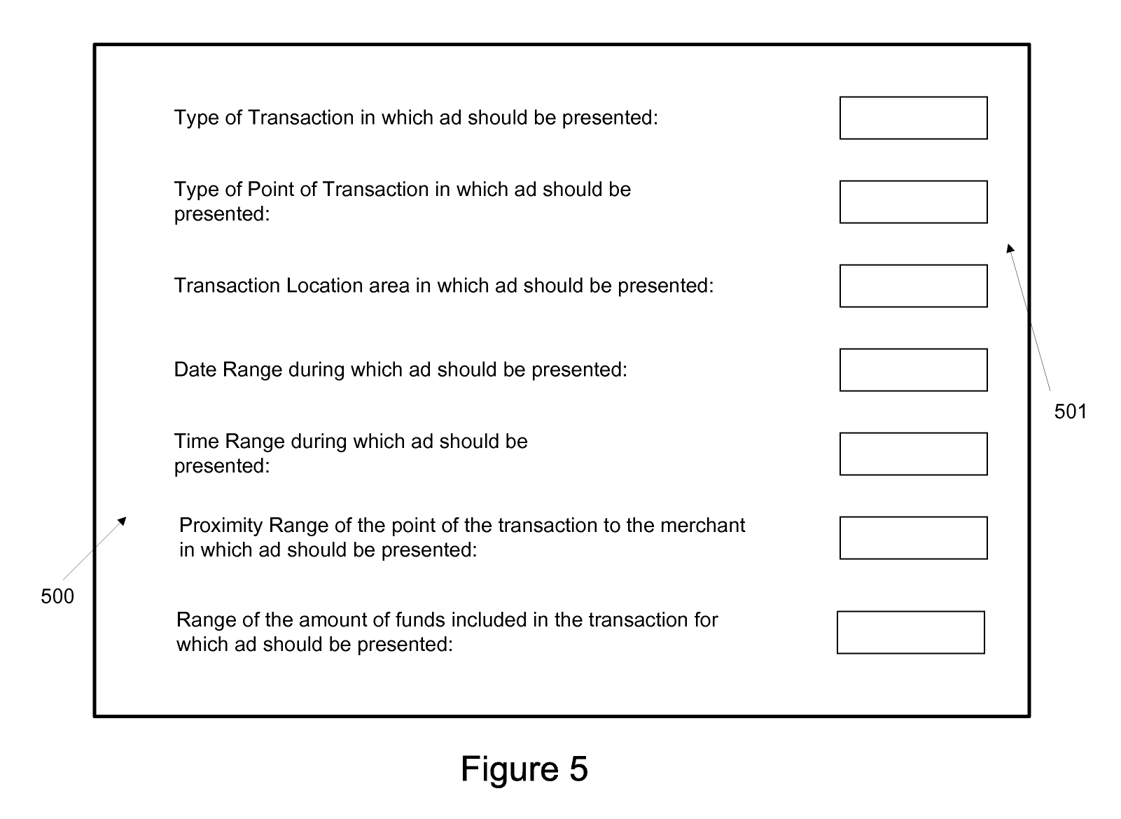

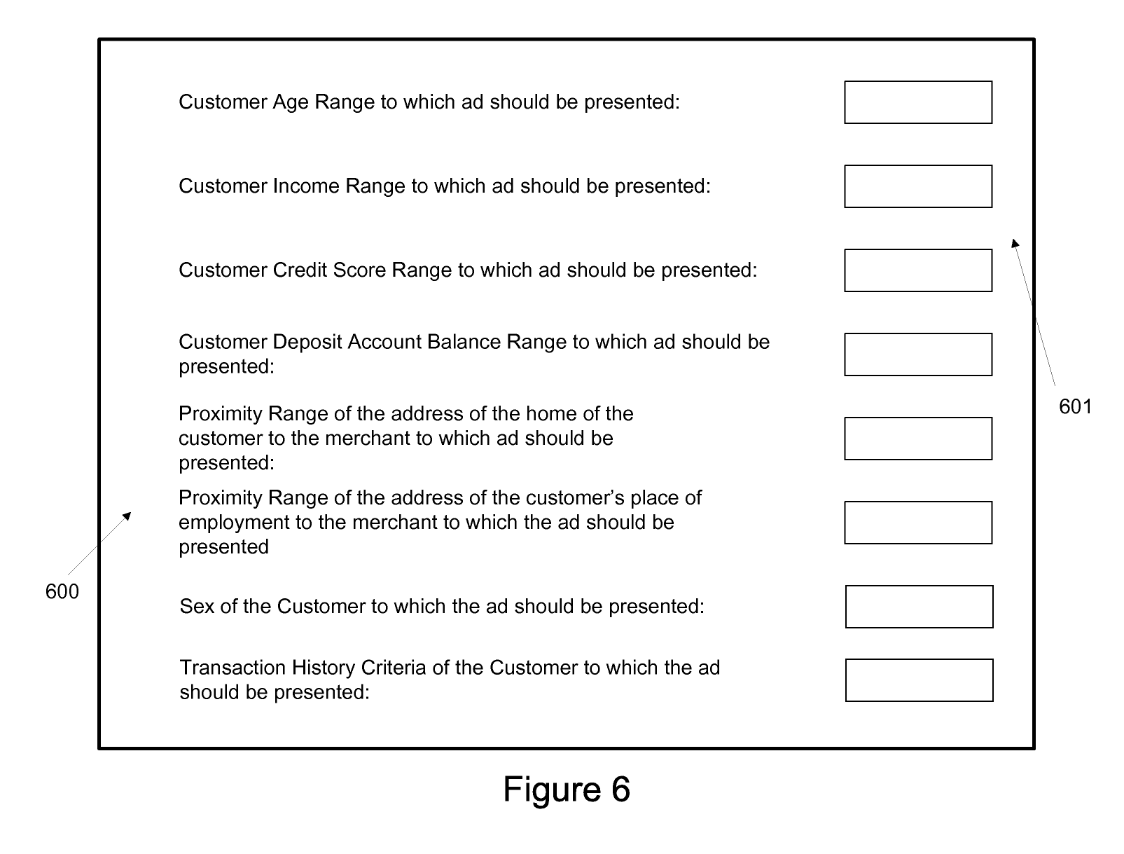

As discussed above, the advertiser's advertising account may be part of a web based system 219 and include fields for the advertiser 215 to enter characteristics of the intended audience to which the advertiser 215 would like the advertisement displayed. For example, FIG. 5 shows an illustrative screen shot 500 of a feature of the advertiser's advertising account in which the advertiser 215 may define characteristics of the intended audience to which the advertiser 215 would like the advertisement displayed. As seen in FIG. 5, the screen shot includes one or more fields 501 which relate to characteristics of the intended audience to which the advertiser 215 would like the advertisement displayed. As seen in FIG. 5, the characteristics relate to data about the transaction itself. Further, FIG. 6 shows an illustrative screen shot 600 of a feature of the advertiser's advertising account in which the advertiser 215 may define characteristics of the intended audience to which the advertiser 215 would like the advertisement displayed. As seen in FIG. 6, the screen shot includes one or more fields 601 which relate to characteristics of the intended audience to which the advertiser 215 would like the advertisement displayed. As seen in FIG. 6, the characteristics relate to data about the customer 201 conducting the transaction.

As described above, according to aspects of the disclosure, the advertising system 200 may include an advertisement optimization engine 211. The advertisement optimization engine 211 may determine which advertisement stored in the advertisement repository 213 should be displayed to the customer 201 during a particular transaction. For example, according to aspects of the disclosure, the advertisement optimization engine 211 may use the characteristics of the intended audience to which the advertiser 215 would like an advertisement displayed in determining which advertisement to display to the customer 201 during a transaction.

According to aspects of the disclosure, once the advertiser 215 has provided which characteristics of the intended audience to which the advertiser 215 would like the advertisement displayed, the list of characteristics may be stored with the advertisement and uploaded to the advertising system 200 via the computer system 217. The characteristics will remain associated with the advertisement itself. Therefore, the advertisement, along with the characteristics of the intended audience to which the advertiser 215 would like the advertisement displayed, may be stored in the advertisement repository 213 upon being approved by the organization 203.

As discussed above, according to aspects of this disclosure, the advertisement optimization engine 211 may determine which advertisements stored in the advertisement repository 213 should be presented to customer 201 during a particular transaction. According to aspects of the disclosure, when a transaction is conducted, the point of transaction 205 may transmit information regarding the transaction to the advertisement optimization engine 211. Such information regarding the transaction itself may include: that a transaction is actually being conducted; the type of transaction (e.g., withdrawal, deposit, balance inquiry, transfer of funds, etc.); the type of point of the transaction through which the transaction is being conducted (e.g., whether transaction is occurring at ATM, counter transaction, online transaction, telephone transaction, etc.); the location of the point of the transaction, the date of the transaction, time of the transaction, etc. Further, according to aspects of the disclosure, some form of authentication may be required by the customer 201 in order to conduct the transaction (e.g., one or more of the authentication methods described above may be employed). In such a case, the authentication system 207 may authenticate the customer 201 including transmitting data related to the authentication to the organization's database 209 and also the advertisement optimization engine 211. It is noted that, as seen in FIG. 2, the advertisement optimization engine 211 may also receive data from the organization's database 209. According to aspects of the disclosure, in authenticating the customer 201 conducting a transaction, the identity of the customer 201 is obtained. For example, the authentication system 207 may request and receive such information from the organization's database 209. Further, either, or both, of the authentication system 207 and the organization's database 209 may transmit such identity information to the advertisement optimization engine 211. Therefore, using the identity of the customer 201 who is being authenticated, the advertisement optimization engine 211 can request and receive additional information from the organization's database 209 about customer 201. It is noted that such information about the customer 201 may be stored in a customer profile in the organization database 209. According to aspects of the disclosure, customer profile information may include data about current customers and their financial relationships with the business, such as: customer name, address, telephone number, email address, age, sex, credit score, income, debt, place of employment (and its contact information, such as address, telephone numbers, etc.), the type of financial relationship/account (e.g., a loan, insurance, savings account, checking account, etc.), term of the relationship (e.g., term of a loan, the time current customer has been with the bank), account balances, transaction history (including trends in banking history (e.g., ATM usage) etc.), etc.

Hence, it is understood that the advertisement optimization engine 211 may receive customer profile data from the organization's database 209 and the authentication system 207, transaction data from the point of transaction 205 and the authentication system 207 and leverage such data to determine which advertisement to present to the customer 201 during the transaction. According to aspects of the disclosure, the advertisement optimization engine 211 may compare customer profile data and transaction data with the advertisements stored in the advertisement repository 213 along with the advertisement's associated characteristics of the intended audience to which the advertiser 215 would like the advertisement displayed. Based on the comparison of such information, the advertisement optimization engine 211 may determine which advertisement to retrieve of the advertisement repository 213 and present to the customer 201 during the transaction.

For example, according to aspects of the disclosure, as described above, the advertisement optimization engine 211 may receive transition data from the point of transaction 205. The advertisement optimization engine 211 may compare one or more elements of this transaction data with the above described characteristics of the advertisements stored in the advertisement repository 213 in order to determine one or more advertisements that may be presented to the customer 201 during the transaction. For example, advertisement optimization engine 211 may compare what type of transaction is being conducted (e.g., withdrawal, deposit, balance inquiry, transfer of funds, etc.), the type of the point of transaction 205 at which the transaction is being conducted, (e.g., an ATM, counter transaction, online transaction, telephone transaction, etc.), the location of the point of the transaction, the date of the transaction, the time of the transaction, with the advertisements and their respective categories of characteristics of the intended audience to which the advertiser 215 would like the advertisement displayed. If there are any advertisements stored in the advertisement repository 213 which have one or more characteristics of the intended audience to which the advertiser 215 would like the advertisement displayed that correspond to the transaction data received from the point of transaction 205, then the advertisement optimization engine 211 may consider such advertisements as potential advertisements to be presented to the customer 201 during the transaction. For example, if the transaction data indicates that a withdrawal of $100 is being is being conducted at an ATM at the intersection of 13^{th} and L Streets on November 28 at 11:00 pm and one or more of the advertisements includes characteristics of the intended audience that correspond to such data (e.g., an advertisement has characteristics of the intended audience which include: withdrawals of over $50 from an ATM between 7:00 pm and 1:00 am), then the advertisement optimization engine 211 may consider such advertisements as potential advertisements to be displayed to the customer 201 during the transaction. It is noted that according to aspects of the disclosure, the potential advertisements may be prioritized according to the number of different characteristics that match the transaction data. In other words, advertisements which have the most associated characteristics of the intended audience that match the transaction data may be ranked higher in a list of potential advertisements to be presented to a customer 201, than advertisements which have less associated characteristics of the intended audience that match the transaction data.

Similarly, according to aspects of the disclosure, as described above, the advertisement optimization engine 211 may receive information from authentication system 207 and the organization database 209 regarding the customer 201 conducting the transaction. According to aspects of the disclosure, in order to determine one or more advertisements that may be presented to the customer 201 during the transaction, the advertisement optimization engine 211 may compare one or more elements of this data with the above described characteristics of the intended audience to which the advertisements stored in the advertisement repository 213 are to be presented. For example, advertisement optimization engine 211 may compare the customer data with: the age range of the customer 201 to which the advertisement is to be presented, the income level range of the customer 201 to which the advertisement is to be presented, the credit score range of the customer 201 to which the advertisement is to be presented, the deposit account balance range of the customer 201 to which the advertisement is to be presented, the proximity range of the customer's home address to a location of the merchant, the proximity range of the address of the customer's place of employment to a location of the merchant, sex of the customer, transaction history criteria of the customer, or other characteristics of the intended audience to which the advertisements are to be presented. If there are any advertisements stored in the advertisement repository 213 which have one or more characteristics of the intended audience to which the advertiser 215 would like the advertisement displayed that correspond to the customer data received from the authentication system 207 or the organization database 209, then the advertisement optimization engine 211 may consider such advertisements as potential advertisements to be displayed to the customer 201 during the transaction. For example, if the customer data indicates that the customer 201 is a 25 year old male with an income of $40,000 and the advertisement repository 213 has one or more of advertisements which have characteristics of the intended audience that correspond to such data (e.g., the characteristics of the intended audience of an advertisement include males between 20-30), then the advertisement optimization engine 211 may consider such advertisements as potential advertisements to be displayed to the customer 201 during the transaction. It is noted that according to aspects of the disclosure, the potential advertisements may be prioritized according to the number of different characteristics that match the customer data. In other words, advertisements which have the most associated characteristics of the intended audience that match the customer data may be ranked higher in a list of potential advertisements to be presented to a customer 201 than advertisements which have the less associated characteristics of the intended audience that match the customer data.

It is noted that, as described above, according to aspects of the disclosure, the advertisement optimization engine 211 may receive information from the organization database 209 regarding the regarding the customer 201 conducting the transaction. Such customer information may include the transaction history of the customer 201. For example, itemized purchases of the customer 201 may be included in the transaction history. The advertisement optimization engine 211 may leverage this customer data to determine one or more advertisements to be presented to the customer 201 during the transaction. For example, if the customer 201 usually makes purchases from a particular eatery, and an advertisement for that eatery is stored in the ad repository 213, then the advertisement optimization engine 211 may display the advertisement for that eatery. It is noted that such information (e.g., the top five merchants from which the customer 201 purchases may be already determined and stored in the customer profiles for quick reference). Further, such information may also be correlated and combined with other of the listed characteristics (e.g., the time of day, date, etc.). For example, if the customer 201 usually purchases from a particular eatery for lunch and, also, purchases from a different, particular eatery for dinner, the advertisement optimization engine 211 may display different advertisements depending on the time of day the transaction is made (e.g., the advertisement optimization engine 211 may present a coupon for the first eatery, if a transaction is made during the day or the advertisement optimization engine 211 may present a coupon for the second eatery if a transaction is made during the evening). Further, it is noted that according to aspects of the disclosure, such transaction history information can also be used by an advertiser to focus the particular audience to which the advertiser would like the advertisement displayed. For example, as shown in FIG. 6, the advertising account may have a feature which allows the advertiser 215 to define a characteristic of the transaction data for the intended audience to which the advertisement should be displayed. For example, the advertiser may define that if transaction history of the customer indicates that they have made at least five purchases from the merchant in the past year, then such a customer making a transaction should be included as part of the intended audience to which the advertisement should be displayed.

Therefore, based on the above discussion, it is understood, the advertisement optimization engine 211 may determine one or more advertisements to be presented to the customer 201 during the transaction, based on the comparison of the customer data, transaction data, transaction history, etc. with the advertisements that are stored in the advertisement repository 213 and their characteristics of the intended audience to which the advertiser 215 would like the advertisements displayed. For example, according to aspects of this disclosure the potential advertisements may be prioritized according to the total number of different characteristics that match the both the transaction data and customer data. In other words, advertisements which have the most associated characteristics of the intended audience that match the transaction data and the customer data may be ranked higher in a list of potential advertisements to be presented to a customer 201 than advertisements which have less associated characteristics of the intended audience that match the transaction data on customer data. Further, if the transaction data indicates a particular trend in the customer's transaction history, then an advertisement for product or service related to that transaction history may be given priority of over other advertisements.

Further, it is noted that the advertisement optimization engine 211 may consider other factors also in determining which advertisement to select and present to a customer during a transaction. For example, according to aspects of this disclosure, the advertisement optimization engine 211 may consider if a particular quota of times that an advertisement is scheduled to be displayed has not yet been met. If not, then the advertisement optimization engine 211 may give that advertisement priority over other advertisements. Further, the advertisement optimization engine 211 may consider factors such as the frequency with which an advertisement has already been displayed or if an advertisement is near expiration when a particular quota of times that an advertisement is scheduled to be displayed has not yet been met may be used.

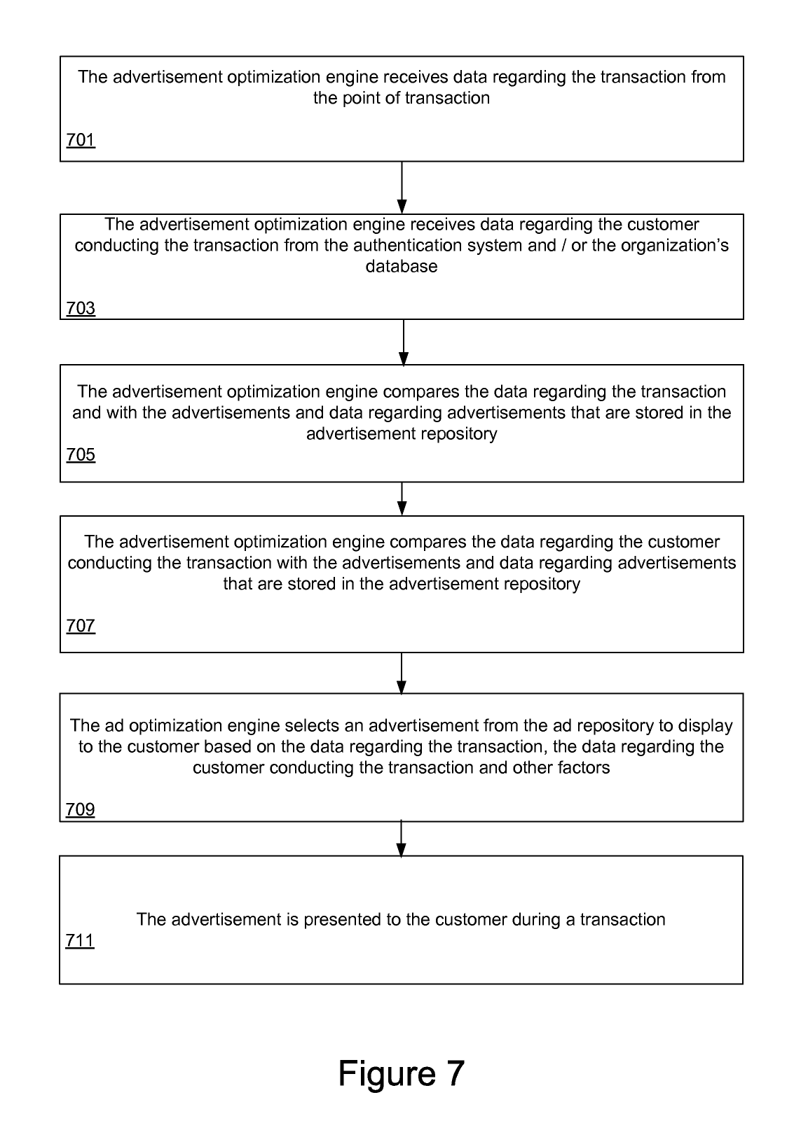

FIG. 7 is a flowchart of an illustrative method for selecting an advertisement to be presented to a customer conducting a transaction according to at least one aspect of the present disclosure. As seen in step 701, the advertisement optimization engine 211 receives data regarding the transaction. As seen in step 703, the advertisement optimization engine 211 receives data regarding the customer 201 conducting the transaction from the authentication system 2097 and/or the organization's database 209. As seen in step 705, the advertisement optimization engine 211 compares the data regarding the transaction and with the advertisements and data regarding advertisements that are stored in the advertisement repository 213. As seen in step 707, the advertisement optimization engine 211 compares the data regarding the customer conducting the transaction with the advertisements and data regarding advertisements that are stored in the advertisement repository 213. As seen in step 709, the ad optimization engine 211 selects an advertisement from the ad repository 213 to display to the customer based on the data regarding the transaction, the data regarding the customer conducting the transaction and other factors. As seen in step 711, the advertisement is presented to the customer during a transaction.

It is noted that the advertising system 200 may be an electronically based system. For example, the system may include a computer (such as described above), a network of computers, software that configures a computer to perform the above described features, etc. The data, such as the transaction data, customer data, etc. may be electronically transmitted and received by the different elements of the advertising system 200.

While illustrative systems and methods as described herein embodying various aspects of the present disclosure are shown, it will be understood by those skilled in the art, that the disclosure is not limited to these embodiments. Modifications may be made by those skilled in the art, particularly in light of the foregoing teachings. For example, each of the features of the aforementioned illustrative examples may be utilized alone or in combination or subcombination with elements of the other examples. It will also be appreciated and understood that modifications may be made without departing from the true spirit and scope of the present disclosure. The description is thus to be regarded as illustrative instead of restrictive on the present disclosure.

1. A computer assisted method for selecting one or more transmissions of transformed data to be presented to a user comprising:
uploading the one or more transmissions of transformed data into a repository database when the one or more transmissions of transformed data are approved by a first entity;
electronically receiving data relating to the identity of the user conducting a first user event;
electronically receiving data relating to the one or more transmissions of transformed data;
determine, by an optimization computer of the first entity, a particular transmission of transformed data to present to the user during the first user event based on the received data by:
comparing the received data relating to the identity of the user with the received data relating to the one or more transmissions of transformed data, wherein the comparing yields a comparison;
prioritizing the one or more transmissions of transformed data based on the comparison; and
selecting a particular transmission of transformed data from the repository to be presented during the first user event based on the comparison,
wherein the data relating to the one or more transmissions of transformed data includes one or more characteristics of an intended audience to which the respective transmissions of transformed data should be presented,
wherein comparing the data relating to the identity of the user with the data relating to the one or more transmissions of transformed data includes determining the characteristics of the one or more transmissions of transformed data which match the data related to the identity of the user;
wherein prioritizing the one or more transmissions of transformed data based on the comparison includes prioritizing the one or more transmissions of transformed data based on a number of characteristics of each of the one or more notifications that match the data related to the identity of the user;
presenting the particular transmission of transformed data of the one or more transmissions of transformed data to the user via a printed document generated during the first customer event, the printed document including embedded information identifying a location of the first user event;
receiving a notice that the printed document including the particular transmission of transformed data was surrendered to a second entity, the notice including the information identifying location of the first user event; and
modifying, based on the notice, one or more transmissions of transformed data for presentation during a second user event.

2. The computer assisted method of claim 1, wherein the printed document includes an alphanumerical code, data glyph, or bar code including the information identifying the location of the first user event.

3. The computer assisted method of claim 1, wherein data relating to the identity of the user includes at least one of: an age of the user, a proximity range of the user's home address to a location of a merchant, a proximity range of an address of a user's place of employment to the location of a merchant, the sex of the user.

4. The computer assisted method of claim 3, wherein the one or more characteristics of an intended audience to which the respective one or more transmissions of transformed data should be presented includes at least one of: an age range of a user, a proximity range of a user's home address to a location of a merchant, a proximity range of an address of the user's place of employment to a location of a merchant, and a sex of a user.

5. The computer assisted method of claim 1, wherein the first user event is conducted at a personal computer.

6. The computer assisted method of claim 1, wherein the data relating to the identity of the user is received by the optimization computer from a database storing user profile data.

7. An system for providing transmissions of transformed data, comprising:
at least one processor; and
at least one memory storing computer executable instructions that, when executed, cause the at least one processor to:
upload one or more transmissions of transformed data into a repository database when the one or more transmissions of transformed data are approved by a first entity;
electronically receive data relating to the identity of a user conducing a first user event;
electronically receive data relating to the one or more transmissions of transformed data;
determine, by an optimization computer of the first entity, a particular transmission of transformed data to present to the user during the first user event based on the received data by:
comparing the data relating to the identity of the user with the data relating to the one or more transmissions of transformed data, wherein the comparing yields a comparison;
prioritizing the one or more transmissions of transformed data based on the comparison; and
selecting the particular transmission of transformed data from the repository database to be presented during the first user event based on the comparison,
wherein the data relating to the one or more transmissions of transformed data includes one or more characteristics of an intended audience to which the respective transmissions of transformed data should be presented,
wherein comparing the data relating to the identity of the user with the data relating to the one or more transmissions of transformed data includes determining the characteristics of the one or more transmissions of transformed data that match the data relating to the identity of the user;
wherein prioritizing the one or more transmissions of transformed data based on the comparison includes prioritizing the one or more transmissions of transformed data based on a number of characteristics of each of the one or more transmissions of transformed data that matches the data relating to the identity of the user;
present the particular transmission of transformed data of the one or more transmissions of transformed data to the user via a printed document generated during the first customer event, the printed document including embedded information identifying a location of the first user event;
receive a notice that the printed document including the particular transmission of transformed data was surrendered to a second entity, the notice including the information identifying the location of the first user event; and
modify, based on the notice, one or more transmissions of transformed data for presentation during a second user event.

8. The system according to claim 7, wherein the printed document includes an alphanumerical code, data glyph, or bar code including the information identifying the location of the first user event.

9. The system according to claim 7, wherein data relating to the identity of the user includes at least one of: an age of the user, a proximity range of the user's home address to a location of a merchant, a proximity range of the address of the user's place of employment to the location of the merchant, the sex of the user.

10. The system according to claim 9, wherein the one or more characteristics of an intended audience to which the respective one or more transmissions of transformed data should be presented includes at least one of: an age range of a user, a proximity range of a user's home address to a location of a merchant, a proximity range of the address of a user's place of employment to a location of a merchant, a sex of a user.

11. The system according to claim 7, wherein the first user even is conducted at a personal computer.

12. The system according to claim 11, wherein the data relating to the identity of the user is received by the optimization computer from a database storing user profile data.

13. A non-transitory computer-readable storage media having computer-executable instructions stored thereon that, when executed by at least one processor, cause the at least one processor to:
upload one or more advertisements into a repository database when the one or more advertisements are approved by a first entity;
electronically receive data relating to the identity of a user conducting a transaction;
electronically receive data relating to the one or more advertisements;
determine, by an optimization computer of the first entity, a particular advertisement to present to the user during the transaction based on the received data by:
comparing the data relating to the identity of the user with the data relating to the one or more advertisements, wherein the comparing yields a comparison;
prioritizing the one or more advertisements based on the comparison; and
selecting the particular advertisement from the repository database to be presented during the transaction based on the comparison,
wherein the data relating to the one or more advertisements includes one or more characteristics of an intended audience to which the respective advertisement should be presented,
wherein comparing the data relating to the identity of the user with the data relating to the one or more advertisements includes determining the characteristics of the one or more advertisements that match the data relating to the identity of the user;
wherein prioritizing the one or more advertisements based on the comparison includes prioritizing the one or more advertisements based on a number of characteristics of each of the one or more advertisements that matches the data relating to the identity of the user;
present the particular advertisement of the one or more advertisements to the user via a printed document generated during the transaction, the printed document including embedded information identifying a location of the transaction;
receive a notice that the printed document including the particular advertisement was surrendered to a second entity, the notice including the information identifying the location of the transaction; and
modify, based on the notice, one or more advertisements for presentation during a second transaction.

14. The non-transitory computer-readable storage media according to claim 13, wherein the printed document includes an alphanumerical code, data glyph, or bar code including the information identifying the location of the transaction.

15. The non-transitory computer-readable storage media according to claim 13, wherein data relating to the identity of the user includes at least one of: an age of the user, a proximity range of the user's home address to a location of a merchant, a proximity range of the address of the user's place of employment to the location of the merchant, the sex of the user.

16. The non-transitory computer-readable storage media according to claim 15, wherein the one or more characteristics of an intended audience to which the respective one or more advertisements should be presented includes at least one of: an age range of a user, a proximity range of a user's home address to a location of a merchant, a proximity range of the address of a user's place of employment to a location of a merchant, a sex of a user.

17. The non-transitory computer-readable storage media according to claim 13, wherein the transaction is conducted at a personal computer.

18. The non-transitory computer-readable storage media according to claim 13, wherein the data relating to the identity of the user is received by the optimization computer from a database storing user profile data.

19. The non-transitory computer-readable storage media of claim 13, wherein the printed document further includes embedded information identifying a time and date of the transaction.

20. The non-transitory computer-readable storage media of claim 13, wherein the second transaction occurs after the transaction.
